(19) United States
(12) Patent Application Publication
(10) Pub. No.: US 2026/0266355 A1
(43) Pub. Date: Sep. 10, 2026

(54) CABLE HANDLE DEVICE

(71) Applicant: Joe Davis, Eutawville, SC (US)

(72) Inventor: Joe Davis, Eutawville, SC (US)

(21) Appl. No.: 19/072,700

(22) Filed: Mar. 6, 2025

(51) Int. Cl. F16G 11/14

(52) U.S. Cl. CPC F16G 11/14

(57) ABSTRACT

A cable handle device facilitates movement of a cable while allowing the cable to remain in use. The device includes a base and a yoke coupled to and extending up from the base. The yoke defines a channel between opposed arms of the yoke for allowing a section of a cable to extend through the channel. A pin is coupled to the base and offset from the channel to hold and secure the section of cable extending through the channel such that the cable is inhibited from sliding through the channel. A handle is coupled to the base and extends upwardly relative to the base to facilitate lifting the cable when the cable is secured through the channel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to handle devices and more particularly pertains to a new handle device for facilitating movement of a cable while allowing the cable to remain in use.

### (2) Description of Related Art including information disclosed under 37 CFR 1.97 and 1.98.

The prior art relates to handle device. Known devices related to cables, or hoses, or wires, relate to supports or stands for elevating a cable or hose or wire, but lack provision of a handle and structure to allow a cable to be moved and hung while the cable remains in use.

### BRIEF SUMMARY OF THE INVENTION

An embodiment of the disclosure meets the needs presented above by generally comprising a base and a yoke coupled to and extending up from the base. The yoke defines a channel between opposed arms of the yoke for allowing a section of a cable to extend through the channel. A pin is coupled to the base and offset from the channel to hold and secure the section of cable extending through the channel such that the cable is inhibited from sliding through the channel. A handle is coupled to the base and extends upwardly relative to the base to facilitate lifting the cable when the cable is secured through the channel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a cable handle device according to an embodiment of the disclosure.

FIG. 2 is a front view of an embodiment of the disclosure.

FIG. 3 is a top view of an embodiment of the disclosure.

FIG. 4 is a side view of an embodiment of the disclosure.

FIG. 5 is a top rear side perspective view of an embodiment of the disclosure in use.

FIG. 6 is a front view of an embodiment of the disclosure in use.

### DETAILED DESCRIPTION OF THE INVENTION

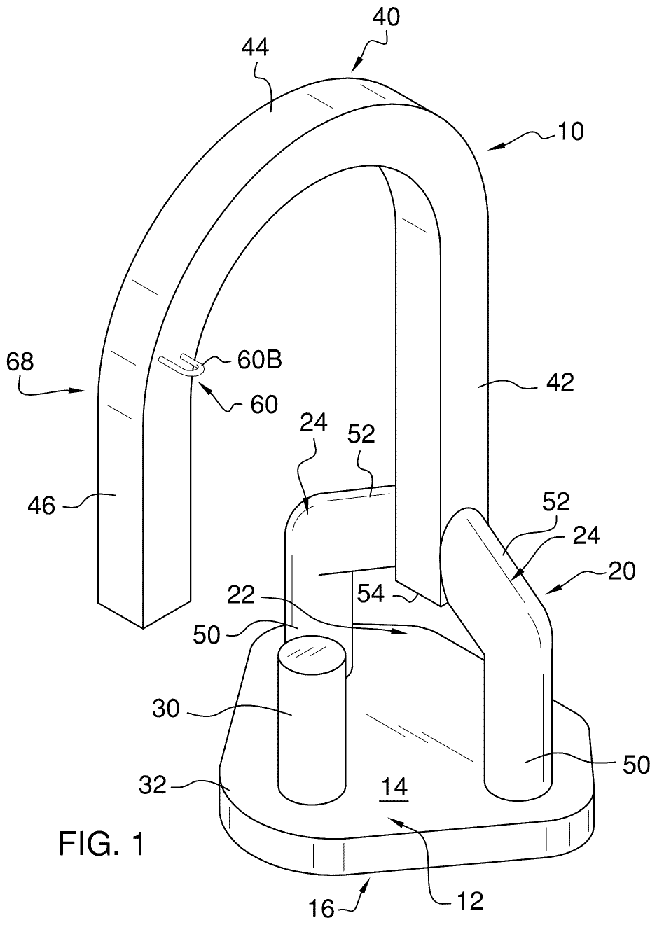

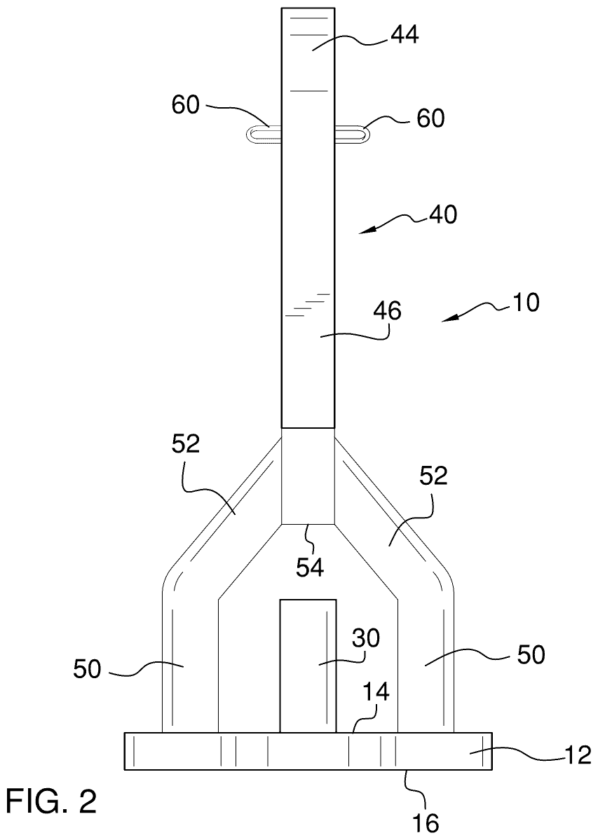

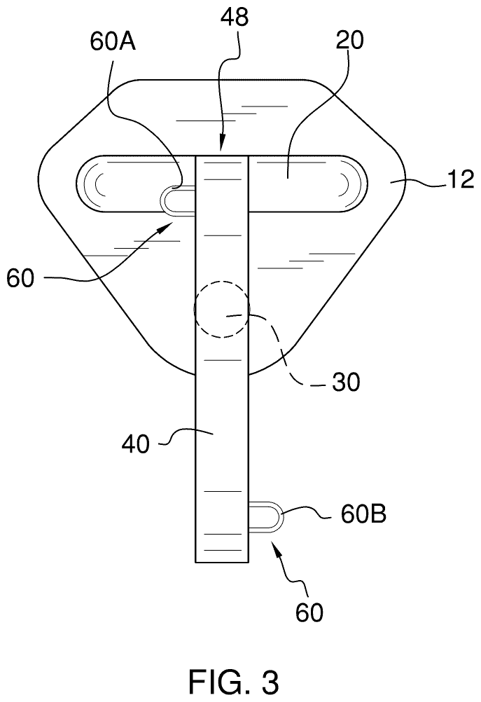

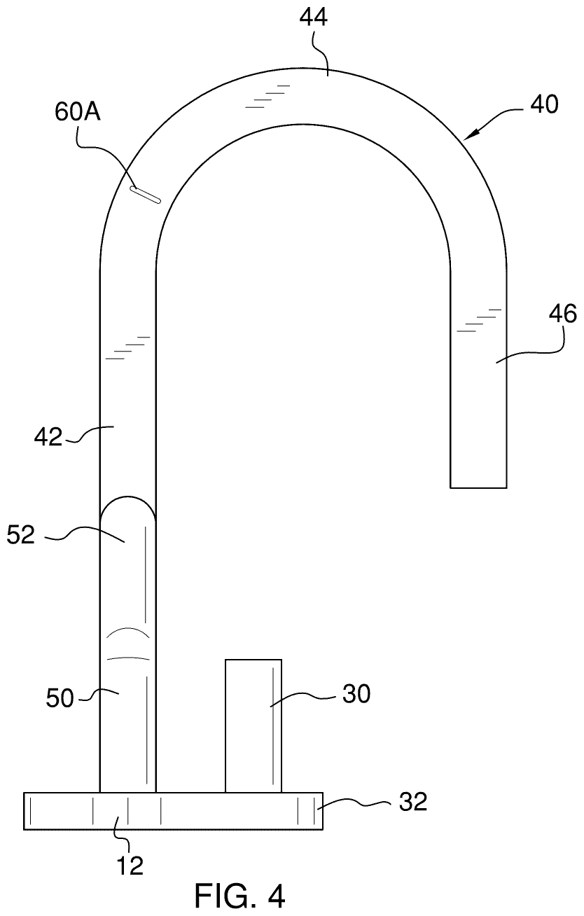

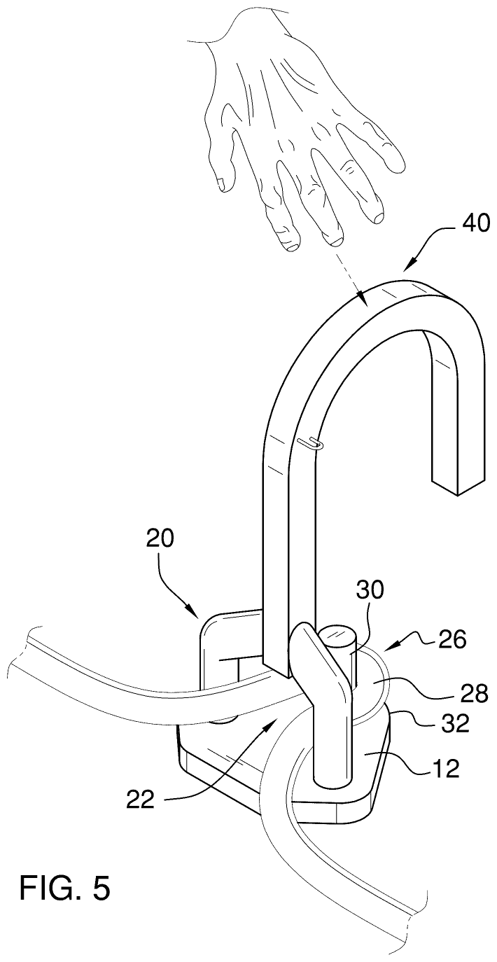

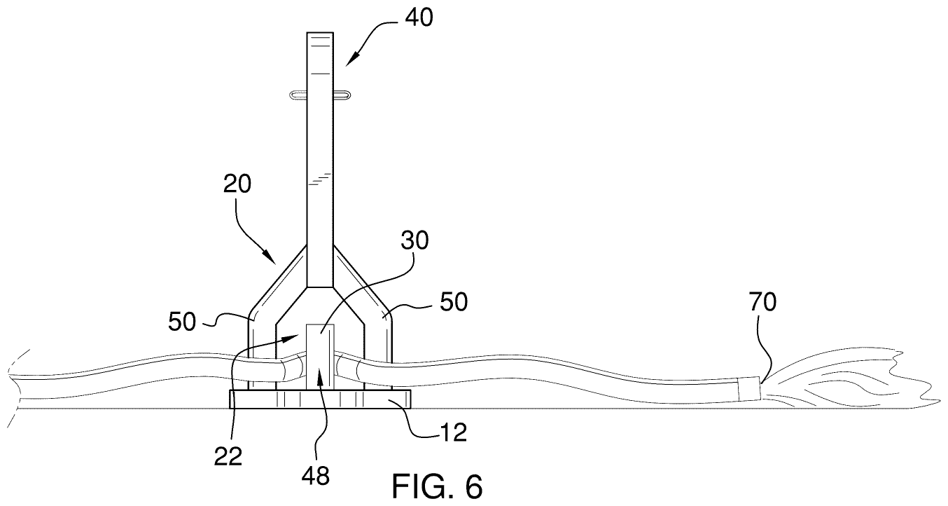

With reference now to the drawings, and in particular to FIGS. 1 through 6 thereof, a new handle device embodying the principles and concepts of an embodiment of the disclosure and generally designated by the reference numeral 10 will be described.

As best illustrated in FIGS. 1 through 6, the cable handle device 10 generally comprises a base 12 having a top surface 14 and a bottom surface 16. Each of the top surface 14 and the bottom surface 16 is planar. The top surface 14 is parallel to the bottom surface 16 such that the base 12 is planar and has a constant thickness. A yoke 20 is coupled to and extends up from the base 12. The yoke 20 defines a channel 22 between opposed arms 24 of the yoke 20. Thus, the yoke 20 is configured for a section 26 of a cable 28 to extend through the channel 22. A pin 30 is coupled to the base 12. The pin 30 is offset from the channel 22 to hold and secure the section 26 of the cable 28 extending through the channel 22 such that the cable 28 is inhibited from sliding through the channel 22 and the device 10 is generally coupled to the cable 28 at a fixed position along the cable 28. The base 12 has an arcuate edge 32 adjacent to the pin 30 and opposite of the yoke 20 relative to the pin 30. The arcuate edge 32 may be generally sized to extend the base 12 to support the section 26 of the cable 28 around the pin 30 but with the cable 28 extending laterally outward relative to the arcuate edge 32.

A handle 40 is coupled to the base 12 directly or through intermediate structure as described further below. The handle 40 extends upwardly relative to the base 12 for lifting the device 10 prior to the cable 28 being secured through the channel 22. The handle 40 is coupled to and extends upwardly from the yoke 20. The handle 40 has a shaft section 42 extending from the yoke 20 and a grip section 44 extending from the shaft section 42. The grip section 44 is arcuate. The handle 40 also has an end section 46 extending from the grip section 44. The end section 46 is parallel to the shaft section 42. The grip section 44 extends over and is coplanar with the pin 30. A width of the channel 22 is greater than a width of the pin 30 and the pin 30 is positioned within a plane perpendicular to and aligned with a center 48 of the channel 22 such that the pin 30 and the yoke 20 allow flow through the cable 28 when the cable 28 is secured through the channel 22. Thus, the device 10 can be lifted and moved as desired. The grip section 44 is further positionable over or engaged to an elevated pipe or similar support such that the base 12 is in an elevated position and the cable 28 is thus held elevated from the ground. The grip section 44 may have a length greater than a distance from the channel 22 to the pin 30 such that the handle 40 extends vertically over and beyond the pin 30.

The yoke 20 includes a pair of upright sections 50 extending perpendicularly from the top surface 14 of the base 12. Each of the upright sections 50 is straight. A respective height of each of the upright sections 50 is equal to a height of the pin 30 facilitating insertion of the section 26 of the cable 28 through the channel 22 and over the pin 30. Each of a pair of angled sections 52 extends from an associated one of the upright sections 50 to a base 54 of the handle 40.

Each of a pair of loops 60 is coupled to and extends laterally from the handle 40. The pair of loops 60 extends from opposite sides of the handle 40 wherein each loop 60 of the pair of loops 60 facilitates securing the handle 40 to a support structure, such as a line, hook or the like, for storage. A first one of the loops 60A is positioned proximate to the shaft section 42 and a second one of the loops 60B is positioned adjacent to an opposite end 68 of the grip section 44 relative to the shaft section 42.

In use, the grip section 44 is engaged to an elevated support and section 26 of the cable 28 is inserted through the channel 22 and over the pin 30. The device 10 may be sized such that the specific dimensions are best suited to the particular type of cable being used. The cable 28 may be housing welding leads with an electrical charge or extension cords, or the like. Additionally, the cable 28 may be a type of hose such as a fire hose or a garden hose. The section 26 of the cable 28 will typically be spaced from an end 70 of the cable 28 where the end 70 of the cable 28. Alternatively, when the cable 28 is of the type not too heavy, the device 10 can rest on the ground and facilitates lifting the section 26 of the cable 28 to reposition as may be needed while providing control of the section 26 of the cable 28 and eliminating having to reach fully to the ground to lift the cable 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cable handle device comprising:
a base;
a yoke coupled to and extending up from said base, said yoke defining a channel between opposed arms of said yoke wherein said yoke is configured for a section of a cable to extend through said channel;
a pin coupled to said base, said pin being offset from said channel wherein said pin is configured to hold and secure the section of cable extending through said channel and the cable is inhibited from sliding through the channel; and
a handle coupled to said base and extending upwardly relative to said base wherein said handle is configured for lifting the cable when the cable is secured through said channel.

2. The cable handle device of claim 1, further comprising said handle being coupled to and extending upwardly from said yoke.

3. The cable handle device of claim 1, further comprising said handle having a shaft section extending from said yoke and a grip section extending from said shaft section.

4. The cable handle device of claim 3, further comprising said grip section being arcuate.

5. The cable handle device of claim 3, further comprising said handle having an end section extending from said grip section, said end section being parallel to said shaft section.

6. The cable handle device of claim 3, further comprising said grip section extending over and being coplanar with said pin.

7. The cable handle device of claim 1, further comprising said base having a top surface and a bottom surface, each of said top surface and said bottom surface being planar, said top surface being parallel to said bottom surface.

8. The cable handle device of claim 1, further comprising a width of said channel being greater than a width of said pin, said pin being positioned within a plane perpendicular to and aligned with a center of said channel.

9. The cable handle device of claim 6, further comprising said grip section having a length greater than a distance from said channel to said pin wherein said handle extends over and beyond said pin.

10. The cable handle device of claim 1, further comprising said base having an arcuate edge adjacent to said pin and opposite of said yoke relative to said pin.

11. The cable handle device of claim 1, wherein said yoke further comprises:
a pair of upright sections extending perpendicularly from said base, each of said upright sections being straight, a respective height of each of said upright sections; and
a pair of angled sections, each angled section extending from an associated one of said upright sections to a base of said handle.

12. The cable handle device of claim 11, further comprising a height of each upright section being equal to a height of said pin.

13. The cable handle device of claim 3, further comprising a pair of loops coupled to and extending laterally from said handle wherein each loop of said pair of loops is configured to facilitate securing said handle to a support structure for storage.

14. The cable handle device of claim 13, further comprising a first one of said loops of said pair of loops being positioned proximate to said shaft section and a second one of said loops of said pair of loops being positioned adjacent to an opposite end of said grip section relative to said shaft section.

15. The cable handle device of claim 13, further comprising said pair of loops extending from opposite sides of said handle.

16. A cable handle device comprising:
a base, said base having a top surface and a bottom surface, each of said top surface and said bottom surface being planar, said top surface being parallel to said bottom surface;
a yoke coupled to and extending up from said base, said yoke defining a channel between opposed arms of said yoke wherein said yoke is configured for a section of a cable to extend through said channel;
a pin coupled to said base, said pin being offset from said channel wherein said pin is configured to hold and secure the section of cable extending through said channel and the cable is inhibited from sliding through the channel, said base having an arcuate edge adjacent to said pin and opposite of said yoke relative to said pin;
a handle coupled to said base and extending upwardly relative to said base wherein said handle is configured for lifting the cable when the cable is secured through said channel, said handle being coupled to and extending upwardly from said yoke, said handle having a shaft section extending from said yoke and a grip section extending from said shaft section, said grip section being arcuate, said handle having an end section extending from said grip section, said end section being parallel to said shaft section, said grip section extending over and being coplanar with said pin;
wherein a width of said channel is greater than a width of said pin, said pin being positioned within a plane perpendicular to and aligned with a center of said channel;
said grip section having a length greater than a distance from said channel to said pin wherein said handle extends over and beyond said pin;
wherein said yoke includes
a pair of upright sections extending perpendicularly from said base, each of said upright sections being straight, a respective height of each of said upright sections, a height of each upright section being equal to a height of said pin, and
a pair of angled sections, each angled section extending from an associated one of said upright sections to a base of said handle. and
a pair of loops coupled to and extending laterally from said handle, said pair of loops extending from opposite sides of said handle wherein each loop of said pair of loops is configured to facilitate securing said handle to a support structure for storage, a first one of said loops of said pair of loops being positioned proximate to said shaft section and a second one of said loops of said pair of loops being positioned adjacent to an opposite end of said grip section relative to said shaft section.
